(19) United States
(12) Patent Application Publication
(10) Pub. No.: US 2026/0142579 A1
(43) Pub. Date: May 21, 2026

(54) POWER CONVERSION SYSTEM

(71) Applicant: Panasonic Intellectual Property Management Co., Ltd., Osaka (JP)

(72) Inventors: Hiroyuki HOSOI, Osaka (JP); Satoshi SAWANO, Osaka (JP)

(21) Appl. No.: 19/119,661

(22) PCT Filed: Dec. 25, 2023
(86) PCT No.: PCT/JP2023/046368

§ 371 Date: Apr. 9, 2025

(30) Foreign Application Priority Data
Dec. 28, 2022 (JP) 2022-212350

(51) Int. Cl. H02M 3/335

(52) U.S. Cl. CPC H02M 3/33576

(57) ABSTRACT

In a power conversion system, a unidirectional AC/DC converter is configured to be connected to a power grid. A bidirectional insulated DC/DC converter has: a first DC input/output terminal and a second DC input/output terminal respectively connected to a first DC output terminal and a second DC output terminal of the unidirectional AC/DC converter; and a third DC input/output terminal and a fourth DC input/output terminal configured to be connected across a battery of an electric vehicle. An inverter has: a first DC input terminal and a second DC input terminal respectively connected to the first DC output terminal and the second DC output terminal of the unidirectional AC/DC converter; and a first AC output terminal and a second AC output terminal configured to be connected to an outlet. An inverter control unit controls the inverter.

### TECHNICAL FIELD

The present disclosure generally relates to a power conversion system, and more particularly relates to a power conversion system to be connected to a battery and outlet of an electric vehicle.

### BACKGROUND ART

Patent Literature 1 discloses a power converter included in a vehicle. The power converter is electrically connected to an inlet, an outlet, and an electrical storage device (i.e., a battery). The power converter includes a first AC/DC converter unit, a DC/AC converter unit, an insulated transformer, and a second AC/DC converter unit. The power converter is connected to the inlet via a first relay. The power converter is connected to the outlet via a second relay. Patent Literature 1 also discloses a PM-ECU for controlling the power converter, the first relay, and the second relay.

In some cases, a power conversion system including the power converter disclosed in Patent Literature 1 may have decreased system efficiency.

### CITATION LIST

### Patent Literature

Patent Literature 1: JP 2013-240241 A

### SUMMARY OF INVENTION

An object of the present disclosure is to provide a power conversion system which may have increased system efficiency.

A power conversion system according to an aspect of the present disclosure includes a unidirectional AC/DC converter, a bidirectional insulated DC/DC converter, an inverter, and an inverter control unit. The unidirectional AC/DC converter has a first AC input terminal, a second AC input terminal, a first DC output terminal, and a second DC output terminal. The unidirectional AC/DC converter is configured to be connected to a power grid. The bidirectional insulated DC/DC converter has: a first DC input/output terminal and a second DC input/output terminal respectively connected to the first DC output terminal and the second DC output terminal of the unidirectional AC/DC converter; and a third DC input/output terminal and a fourth DC input/output terminal configured to be connected across a battery of an electric vehicle. The inverter has: a first DC input terminal and a second DC input terminal respectively connected to the first DC output terminal and the second DC output terminal of the unidirectional AC/DC converter; and a first AC output terminal and a second AC output terminal configured to be connected to an outlet. The inverter control unit controls the inverter.

### BRIEF DESCRIPTION OF DRAWINGS

FIG. 1 is a circuit block diagram of a power conversion system according to a first embodiment;

FIG. 2 is a circuit diagram of the power conversion system;

FIG. 3 is a circuit diagram of a power conversion system according to a second embodiment; and

FIG. 4 is a circuit block diagram of a power conversion system according to a third embodiment.

### DESCRIPTION OF EMBODIMENTS

### First Embodiment

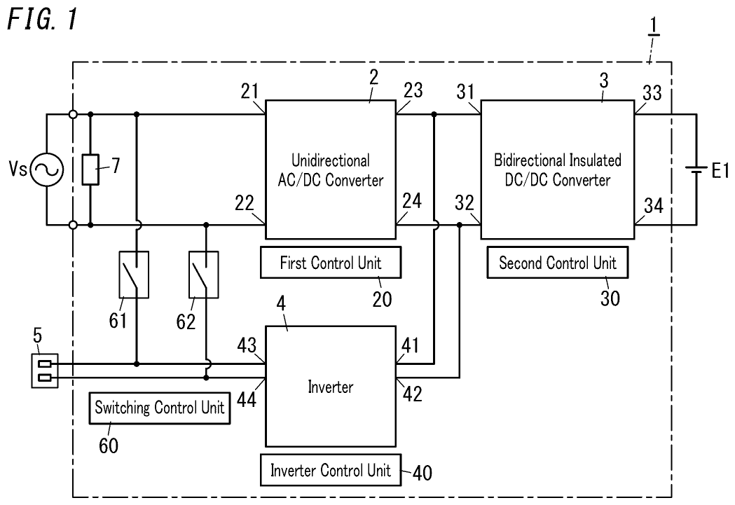

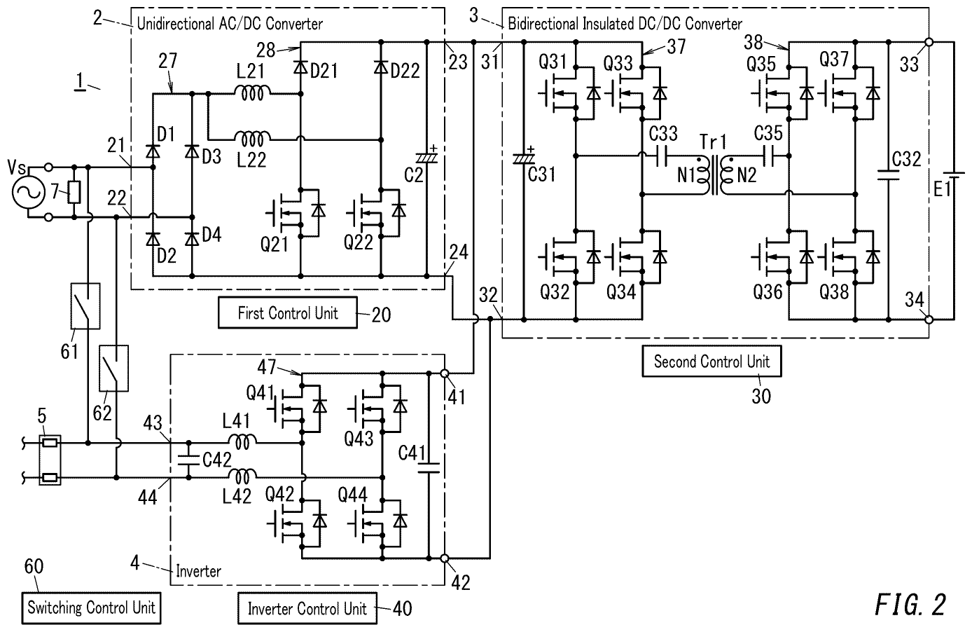

A power conversion system 1 according to a first embodiment will be described with reference to FIGS. 1 and 2.

### (1) Overview

The power conversion system 1 is provided for an electric vehicle (such as an electric car and a hybrid car), for example, and is configured to be connected to a battery E1 of the electric vehicle. The battery E1 is a rechargeable battery of the electric vehicle. The power conversion system 1 may be included, for example, in an onboard charger for use to charge the battery E1 with electricity.

As shown in FIG. 1, the power conversion system 1 includes a unidirectional AC/DC converter 2, a bidirectional insulated DC/DC converter 3, an inverter 4, and an inverter control unit 40. The unidirectional AC/DC converter 2 is configured to be connected to a power grid. The bidirectional insulated DC/DC converter 3 is configured to be connected to the battery E1 of an electric vehicle. The battery E1 may be, for example, a 400 V lithium-ion battery. The inverter 4 is configured to be connected to an outlet 5. The outlet 5 may be, for example, an AC 100 V outlet (also called an “accessory outlet”) installed inside the electric vehicle. A plug of an electric household appliance, for example, is to be connected to the outlet 5. The inverter control unit 40 controls the inverter 4. Note that the power conversion system 1 preferably further includes a first AC filter provided between the unidirectional AC/DC converter 2 and an AC power supply Vs of the power grid. In that case, the unidirectional AC/DC converter 2 is connected to the AC power supply Vs via the first AC filter. The first AC filter is a noise filter. The power conversion system 1 preferably further includes a DC filter provided between the bidirectional insulated DC/DC converter 3 and the battery E1. In that case, the bidirectional insulated DC/DC converter 3 is connected to the battery E1 via the DC filter. The DC filter is a noise filter. The power conversion system 1 preferably further includes a second AC filter provided between the inverter 4 and the outlet 5. In that case, the inverter 4 is connected to the outlet 5 via the second AC filter. The second AC filter is a noise filter.

The power conversion system 1 further includes a first control unit 20 and a second control unit 30. The first control unit 20 controls the unidirectional AC/DC converter 2. The second control unit 30 controls the bidirectional insulated DC/DC converter 3.

The power conversion system 1 further includes a first switch unit 61, a second switch unit 62, and a switching control unit 60. The first switch unit 61 and the second switch unit 62 are provided between the input side of the unidirectional AC/DC converter 2 and the output side of the inverter 4 to allow electricity to be supplied from the power grid to the outlet 5. The switching control unit 60 controls the first switch unit 61 and the second switch unit 62.

The power conversion system 1 further includes a voltage detector circuit 7. The voltage detector circuit 7 detects the input voltage of the unidirectional AC/DC converter 2.

### (2) Details

Next, the power conversion system 1 according to the first embodiment will be described in further detail with reference to FIGS. 1 and 2.

### (2.1) Unidirectional AC/DC Converter

The unidirectional AC/DC converter 2 (hereinafter simply referred to as an “AC/DC converter 2”) has a first AC input terminal 21, a second AC input terminal 22, a first DC output terminal 23, and a second DC output terminal 24. The unidirectional AC/DC converter 2 is configured to be connected to a power grid (e.g., a single-phase AC power supply Vs of the power grid in the example shown in FIG. 1). As used herein, the “power grid” refers to an overall system allowing an electric power supplier such as a power company to supply electricity to consumers'power receiving facilities. The power conversion system 1 is connected to the AC power supply Vs when a charging connector (power feeding plug) of an external charging control unit is connected to a charging inlet (charging port) of an electric vehicle. The AC power supply Vs may be, for example, a commercial power supply. The charging control unit includes, for example, a charging controller, a charging cable, a charging connector, a power cable, and a power plug. The charging controller is interposed between one end of the power cable and one end of the charging cable to control charging from an external power supply (such as the commercial power supply) to the battery E1 of the electric vehicle. The charging controller includes a charge circuit interrupt device (CCID).

The unidirectional AC/DC converter 2 includes, for example, a diode bridge 27 and a boost chopper circuit 28 as shown in FIG. 2.

The diode bridge 27 is formed by bridge-connecting four diodes D1, D2, D3, D4 to full-wave rectify the AC voltage of the AC power supply Vs. In the diode bridge 27, a connection node between the two diodes D1, D2 which are connected in series is connected to the first AC input terminal 21, and a connection node between the two diodes D3, D4 which are connected in series is connected to the second AC input terminal 22.

The boost chopper circuit 28 includes two inductors L21, L22, two switching elements Q21, Q22, two diodes D21, D22, and a smoothing capacitor C2. In the boost chopper circuit 28, a first series circuit of the inductor L21 and the switching element Q21 is connected between the output terminals of the diode bridge 27. Also, in the boost chopper circuit 28, a second series circuit of the inductor L22 and the switching element Q22 is connected between the output terminals of the diode bridge 27. Thus, the second series circuit is connected to the first series circuit in parallel.

Also, in the boost chopper circuit 28, the anode of the diode D21 is connected to the connection node between the inductor L21 and the switching element Q21, and the cathode of the diode D21 is connected to the first DC output terminal 23.

Also, in the boost chopper circuit 28, the anode of the diode D22 is connected to the connection node between the inductor L22 and the switching element Q22, and the cathode of the diode D22 is connected to the first DC output terminal 23.

Furthermore, in the boost chopper circuit 28, the smoothing capacitor C2 is connected between the first DC output terminal 23 and the second DC output terminal 24. The smoothing capacitor C2 may be, for example, an electrolytic capacitor.

In the boost chopper circuit 28, each of the two switching elements Q21, Q22 may be, for example, a normally OFF n-channel metal-oxide semiconductor field effect transistor (MOSET). In FIG. 2, the diodes respectively connected in antiparallel to the two switching elements Q21, Q22 are parasitic diodes for the n-channel MOSFETs serving as the switching elements Q21, Q22. However, this is only an example and should not be construed as limiting. The diodes may also be external diodes.

The two switching elements Q21, Q22 of the AC/DC converter 2 are controlled by the first control unit 20.

The AC/DC converter 2 performs high power factor control to synchronize the phase of an input current for the AC/DC converter 2 with the phase of the AC voltage of the AC power supply Vs, and therefore, is called a power factor correction (PFC) circuit.

### (2.2) Bidirectional Insulated DC/DC Converter

As shown in FIG. 1, the bidirectional insulated DC/DC converter 3 (hereinafter simply referred to as a “DC/DC converter 3”) has a first DC input/output terminal 31, a second DC input/output terminal 32, a third DC input/output terminal 33, and a fourth DC input/output terminal 34. The first DC input/output terminal 31 of the DC/DC converter 3 is connected to the first DC output terminal 23 of the AC/DC converter 2. The second DC input/output terminal 32 of the DC/DC converter 3 is connected to the second DC output terminal 24 of the AC/DC converter 2. The third DC input/output terminal 33 of the DC/DC converter 3 is configured to be connected to a positive electrode of the battery E1 of the electric vehicle. The fourth DC input/output terminal 34 of the DC/DC converter 3 is configured to be connected to a negative electrode of the battery E1. That is to say, in the DC/DC converter 3, the battery E1 is connected between the third DC input/output terminal 33 and the fourth DC input/output terminal 34.

As shown in FIG. 2, the DC/DC converter 3 includes, for example, a transformer Tr1, a first capacitor C31, a second capacitor C32, a first bridge circuit 37, and a second bridge circuit 38. The DC/DC converter 3 further includes a third capacitor C33 and a fourth capacitor C35. The transformer Tr1 includes a primary winding N1 and a secondary winding N2. The first capacitor C31 is connected between the first DC input/output terminal 31 and the second DC input/output terminal 32 of the DC/DC converter 3. The second capacitor C32 is connected between the third DC input/output terminal 33 and the fourth DC input/output terminal 34 of the DC/DC converter 3. Each of the first capacitor C31 and the second capacitor C32 may be, for example, an electrolytic capacitor.

The first bridge circuit 37 is connected between the first terminal and second terminal of the primary winding N1 of the transformer Tr1 via the third capacitor C33. The first bridge circuit 37 includes four switching elements Q31, Q32, Q33, Q34, which are bridge-connected to each other. In the first bridge circuit 37, a series circuit of two switching elements Q31, Q32 and a series circuit of two switching elements Q33, Q34 are connected to the first capacitor C31 in parallel. Also, in the first bridge circuit 37, the connection node between the two switching elements Q31, Q32 is connected to a first terminal of the primary winding N1 via the third capacitor C33 and the connection node between the two switching elements Q33, Q34 is connected to a second terminal of the primary winding N1. In the first bridge circuit 37, each of the four switching elements Q31-Q34 may be, for example, a normally OFF n-channel MOSFET. In FIG. 2, the four diodes connected one to one in antiparallel to the four switching elements Q31-Q34 are parasitic diodes for the n-channel MOSFETs serving as the four switching elements Q31-Q34. However, this is only an example and should not be construed as limiting. The diodes may also be external diodes.

The second bridge circuit 38 is connected between the first terminal and the second terminal of the secondary winding N2 of the transformer Tr1 via the fourth capacitor C35. The second bridge circuit 38 includes four switching elements Q35, Q36, Q37, Q38, which are bridge-connected to each other. In the second bridge circuit 38, a series circuit of two switching elements Q35, Q36 and a series circuit of two switching elements Q37, Q38 are connected to the second capacitor C32 in parallel. Also, in the second bridge circuit 38, the connection node between the two switching elements Q35, Q36 is connected to the first terminal of the secondary winding N2 via the fourth capacitor C35 and the connection node between the two switching elements Q37, Q38 is connected to the second terminal of the secondary winding N2. In the second bridge circuit 38, each of the four switching elements Q35-Q38 may be, for example, a normally OFF n-channel MOSFET. In FIG. 2, the four diodes connected one to one in antiparallel to the four switching elements Q35-Q38 are parasitic diodes for the n-channel MOSFETs serving as the four switching elements Q35-Q38. However, this is only an example and should not be construed as limiting. The diodes may also be external diodes.

In the transformer Tr1, the ratio of the number of turns of the primary winding N1 to the number of turns of the secondary winding N2 may be, for example, one to one. However, this is only an example and should not be construed as limiting.

The DC/DC converter 3 is a bidirectional DC-DC converter which may, for example, convert voltage bidirectionally between the pair of the first DC input/output terminal 31 and the second DC input/output terminal 32 and the pair of the third DC input/output terminal 33 and the fourth DC input/output terminal 34.

More specifically, the DC/DC converter 3 may perform a first conversion operation of converting a first input voltage into a first output voltage and a second conversion operation of converting a second input voltage into a second output voltage.

When performing the first conversion operation, the DC/DC converter 3 uses the voltage between the first DC input/output terminal 31 and the second DC input/output terminal 32 as the first input voltage and uses the voltage between the third DC input/output terminal 33 and the fourth DC input/output terminal 34 as the first output voltage. That is to say, when performing the first conversion operation, the DC/DC converter 3 converts the first input voltage applied between the first DC input/output terminal 31 and the second DC input/output terminal 32 into the first output voltage having a different voltage value from the first input voltage and delivers the first output voltage to between the third DC input/output terminal 33 and the fourth DC input/output terminal 34.

On the other hand, when performing the second conversion operation, the DC/DC converter 3 uses the voltage between the third DC input/output terminal 33 and the fourth DC input/output terminal 34 as the second input voltage and uses the voltage between the first DC input/output terminal 31 and the second DC input/output terminal 32 as the second output voltage. That is to say, when performing the second conversion operation, the DC/DC converter 3 converts the second input voltage applied between the third DC input/output terminal 33 and the fourth DC input/output terminal 34 into the second output voltage having a different voltage value from the second input voltage and delivers the second output voltage to between the first DC input/output terminal 31 and the second DC input/output terminal 32.

In the DC/DC converter 3, the first DC output terminal 23 of the AC/DC converter 2 is connected to the first DC input/output terminal 31, and the second DC output terminal 24 of the AC/DC converter 2 is connected to the second DC input/output terminal 32. Thus, the power grid is connected to between the first DC input/output terminal 31 and second DC input/output terminal 32 of the DC/DC converter 3 via the AC/DC converter 2. In addition, in the DC/DC converter 3, the positive electrode of the battery E1 is connected to the third DC input/output terminal 33 and the negative electrode of the battery E1 is connected to the fourth DC input/output terminal 34.

Therefore, the first conversion operation performed by the DC/DC converter 3 is a charging operation performed by the DC/DC converter 3 to charge the battery E1 with electricity. On the other hand, the second conversion operation performed by the DC/DC converter 3 is a discharging operation performed by the DC/DC converter 3 to discharge electricity from the battery E1.

The eight switching elements Q31-Q38 of the DC/DC converter 3 are controlled by the second control unit 30.

When the DC/DC converter 3 performs the first conversion operation, the four switching elements Q35-Q38 of the second bridge circuit 38 are controlled to OFF state and the four switching elements Q31-Q34 of the first bridge circuit 37 are switched. That is to say, when the DC/DC converter 3 performs the first conversion operation, the four switching elements Q31-Q34 of the first bridge circuit 37 are turned ON and OFF. Note that the switching elements Q35-Q38 may be turned ON during only a part of the period in which a current is flowing.

When the DC/DC converter 3 performs the second conversion operation, the four switching elements Q31-Q34 of the first bridge circuit 37 are controlled to OFF state and the four switching elements Q35-Q38 of the second bridge circuit 38 are switched. That is to say, when the DC/DC converter 3 performs the second conversion operation, the four switching elements Q35-Q38 of the second bridge circuit 38 are turned ON and OFF. Note that the switching elements Q31-Q34 may be turned ON during only a part of the period in which a current is flowing.

### (2.3) Inverter

As shown in FIG. 1, the inverter 4 has a first DC input terminal 41, a second DC input terminal 42, a first AC output terminal 43, and a second AC output terminal 44. The first DC input terminal 41 of the inverter 4 is connected to the first DC output terminal 23 of the AC/DC converter 2. Thus, the first DC input terminal 41 of the inverter 4 is connected to the first DC input/output terminal 31 of the DC/DC converter 3. On the other hand, the second DC input terminal 42 of the inverter 4 is connected to the second DC output terminal 24 of the AC/DC converter 2. Thus, the second DC input terminal 42 of the inverter 4 is connected to the second DC input/output terminal 32 of the DC/DC converter 3. The inverter 4 converts the DC voltage, supplied from the DC/DC converter 3 that converts the output voltage of the battery E1, into an AC voltage and outputs the AC voltage. The inverter 4 is a unidirectional DC/AC converter.

As shown in FIG. 2, the inverter 4 includes a bridge circuit 47, two inductors L41, L42, and two capacitors C41, C42.

The bridge circuit 47 includes four switching elements Q41, Q42, Q43, Q44. In the bridge circuit 47, a series circuit of two switching elements Q41, Q42 and a series circuit of two switching elements Q43, Q44 are connected to the capacitor C41 in parallel. Also, in the bridge circuit 47, the connection node between the two switching elements Q41, Q42 is connected to a first terminal of the outlet 5 via the inductor L41 and the connection node between the two switching elements Q43, Q44 is connected to a second terminal of the outlet 5 via the inductor L42. In the bridge circuit 47, each of the four switching elements Q41-Q44 may be, for example, a normally OFF n-channel MOSFET. In FIG. 2, the four diodes connected one to one in antiparallel to the four switching elements Q41-Q44 are parasitic diodes for the n-channel MOSFETs serving as the four switching elements Q41-Q44. However, this is only an example and should not be construed as limiting. The diodes may also be external diodes.

The capacitor C41 is connected between the first DC input terminal 41 and the second DC input terminal 42. The capacitor C42 is connected between the first AC output terminal 43 and the second AC output terminal 44.

### (2.4) First Switch Unit

The first switch unit 61 is connected between the first AC input terminal 21 of the unidirectional AC/DC converter 2 and the first AC output terminal 43 of the inverter 4. The first switch unit 61 may be, for example, a mechanical relay. The first switch unit 61 is controlled by the switching control unit 60 to turn ON and OFF.

The first switch unit 61 does not have to be a mechanical relay but may also be, for example, a semiconductor switching element or a semiconductor relay. The semiconductor switching element may be, for example, a MOSFET, a bipolar transistor, an insulated gate bipolar transistor (IGBT), or a GaN-based gate injection transistor (GIT).

### (2.5) Second Switch Unit

The second switch unit 62 is connected between the second AC input terminal 22 of the unidirectional AC/DC converter 2 and the second AC output terminal 44 of the inverter 4. The second switch unit 62 may be, for example, a mechanical relay. The second switch unit 62 is controlled by the switching control unit 60 to turn ON and OFF.

The second switch unit 62 does not have to be a mechanical relay but may also be, for example, a semiconductor switching element or a semiconductor relay.

### (2.6) Voltage Detector Circuit

The voltage detector circuit 7 detects the input voltage of the AC/DC converter 2. More specifically, the voltage detector circuit 7 is connected between the first AC input terminal 21 and the second AC input terminal 22 of the AC/DC converter 2 to detect, as the input voltage of the AC/DC converter 2, the voltage between the first AC input terminal 21 and the second AC input terminal 22. The voltage detector circuit 7 may be, for example, a resistance divider circuit including a plurality of resistors which are connected in series.

### (2.7) First Control Unit, Second Control Unit, Inverter Control Unit, and Switching Control Unit

The first control unit 20 controls the two switching elements Q21, Q22 of the AC/DC converter 2. The first control unit 20 generates, in accordance with an external command or the input voltage of the AC/DC converter 2, for example, two control signals corresponding one to one to the two switching elements Q21, Q22 and outputs the two control signals. Each of the two control signals may be, for example, a voltage, of which the voltage level alternates between a voltage value (of 10 V, for example) higher than a gate threshold voltage of a corresponding one (MOSFET) of the two switching elements Q21, Q22 and a voltage value (of 0 V, for example) lower than the gate threshold voltage.

The second control unit 30 controls the four switching elements Q31-Q34 of the first bridge circuit 37 of the DC/DC converter 3 and the four switching elements Q35-Q38 of the second bridge circuit 38 thereof. The second control unit 30 generates, in accordance with an external command, the input voltage of the DC/DC converter 3, or an input current, for example, control signals for the eight switching elements Q31-Q38 and outputs the eight control signals.

If the DC/DC converter 3 is made to perform the first conversion operation, the second control unit 30 repeatedly performs control for first through fourth periods with the four switching elements Q35-Q38 of the second bridge circuit 38 turned OFF. Specifically, the first period is a period in which the switching element Q31 is turned OFF, the switching element Q32 is turned ON, the switching element Q33 is turned ON, and the switching element Q34 is turned OFF. The second period is a period in which the switching element Q31 is turned OFF, the switching element Q32 is turned OFF, the switching element Q33 is turned OFF, and the switching element Q34 is turned OFF (i.e., a dead time period). The third period is a period in which the switching element Q31 is turned ON, the switching element Q32 is turned OFF, the switching element Q33 is turned OFF, and the switching element Q34 is turned ON. The fourth period is a period in which the switching element Q31 is turned OFF, the switching element Q32 is turned OFF, the switching element Q33 is turned OFF, and the switching element Q34 is turned OFF (i.e., a dead time period).

If the DC/DC converter 3 is made to perform the second conversion operation, the second control unit 30 repeatedly performs control for fifth through eighth periods with the four switching elements Q31-Q34 of the first bridge circuit 37 turned OFF. Specifically, the fifth period is a period in which the switching element Q35 is turned OFF, the switching element Q36 is turned ON, the switching element Q37 is turned ON, and the switching element Q38 is turned OFF. The sixth period is a period in which the switching element Q35 is turned OFF, the switching element Q36 is turned OFF, the switching element Q37 is turned OFF, and the switching element Q38 is turned OFF (i.e., a dead time period). The seventh period is a period in which the switching element Q35 is turned ON, the switching element Q36 is turned OFF, the switching element Q37 is turned OFF, and the switching element Q38 is turned ON. The eighth period is a period in which the switching element Q35 is turned OFF, the switching element Q36 is turned OFF, the switching element Q37 is turned OFF, and the switching element Q38 is turned OFF (i.e., a dead time period).

The inverter control unit 40 controls the four switching elements Q41-Q42 of the bridge circuit 47 of the inverter 4. The inverter control unit 40 generates, in accordance with an external command or the input voltage of the inverter 4, for example, four control signals for the four switching elements Q41-Q44 and outputs the four control signals. The inverter control unit 40 performs pulse width modulation (PWM) control on each of the four switching elements Q41-Q44.

When performing the operation of converting the input DC voltage into an AC voltage, the inverter control unit 40 repeatedly performs control for ninth through twelfth periods. Specifically, the ninth period is a period in which the switching element Q41 is turned OFF, the switching element Q42 is turned ON, the switching element Q43 is turned ON, and the switching element Q44 is turned OFF. The tenth period is a period in which the switching element Q41 is turned OFF, the switching element Q42 is turned OFF, the switching element Q43 is turned OFF, and the switching element Q44 is turned OFF (i.e., a dead time period). The eleventh period is a period in which the switching element Q41 is turned ON, the switching element Q42 is turned OFF, the switching element Q43 is turned OFF, and the switching element Q44 is turned ON. The twelfth period is a period in which the switching element Q41 is turned OFF, the switching element Q42 is turned OFF, the switching element Q43 is turned OFF, and the switching element Q44 is turned OFF (i.e., a dead time period).

The switching control unit 60 controls the first switch unit 61 and the second switch unit 62. While the DC/DC converter 3 is charging the battery E1 with electricity, the switching control unit 60 controls the first switch unit 61 and the second switch unit 62 to ON state. The switching control unit 60 may determine, in accordance with, for example, the voltage detected by the voltage detector circuit 7 or the detection result obtained by a sensor that determines whether a charging connector is connected to a charging inlet of an electric vehicle or not, whether the DC/DC converter 3 is charging the battery E1 with electricity.

On the other hand, while the DC/DC converter 3 is not charging the battery E1 with electricity, the switching control unit 60 controls the first switch unit 61 and the second switch unit 62 to OFF state. While the DC/DC converter 3 is not charging the battery E1 with electricity, the inverter control unit 40 controls the inverter 4 to cause the DC/DC converter 3 to make voltage conversion of a first DC voltage of the battery E1 and thereby convert a second DC voltage to be output to between the first DC input/output terminal 31 and the second DC input/output terminal 32 into an AC voltage for the outlet 5. The AC voltage of the outlet 5 may be, for example, AC 100 V. However, this is only an example and should not be construed as limiting.

Also, the inverter control unit 40 allows the inverter 4 to operate after a DC bus voltage between the first DC output terminal 23 and the second DC output terminal 24 of the AC/DC converter 2 has exceeded a maximum value of an AC voltage to be supplied from the power grid (e.g., the AC power supply Vs in the example shown in FIG. 2) to the AC/DC converter 2. The inverter control unit 40 may either detect, in accordance with the result of detection obtained by the voltage detector circuit 7, the maximum value of the AC voltage to be supplied from the power grid to the AC/DC converter 2 or store in advance the maximum value of the AC voltage to be supplied from the power grid to the AC/DC converter 2, whichever is appropriate.

If a plug of an electric household appliance is connected to the outlet 5 while the electric vehicle is traveling (i.e., charging suspended state), the power conversion system 1 enters a state where the power conversion system 1 supplies an AC voltage to the outlet 5 through a path that passes through the battery E1, the bidirectional insulated DC/DC converter 3, the inverter 4, and the outlet 5 in this order. If the battery E1 starts to be charged in that state (i.e., the charging suspended state), then the switching control unit 60 controls to keep the first switch unit 61 and the second switch unit 62 OFF. Thus, if the battery E1 starts to be charged in the charging suspended state, an AC voltage is supplied to the outlet 5 through a path that passes through the AC power supply Vs, the unidirectional AC/DC converter 2, the inverter 4, and the outlet 5. On the other hand, if the plug of the electric household appliance is connected to the outlet 5 while the battery E1 is being charged, then the switching control unit 60 controls the first switch unit 61 and the second switch unit 62 to ON state. Thus, the power conversion system 1 enters a state where the power conversion system 1 supplies an AC voltage from the AC power supply Vs to the outlet 5 via the first switch unit 61 and the second switch unit 62, not via the unidirectional AC/DC converter 2 or the inverter 4. If the AC power supply Vs is disconnected in that state, then the voltage detected by the voltage detector circuit 7 falls. Therefore, in the power conversion system 1, the switching control unit 60 immediately controls, in accordance with the result of detection by the voltage detector circuit 7, the first switch unit 61 and the second switch unit 62 to OFF state, and operates to supply the AC voltage to the outlet 5 through a path that passes through the battery E1, the bidirectional insulated DC/DC converter 3, the inverter 4, and the outlet 5 in this order.

The agent that performs the functions of the respective control units (namely, the first control unit 20, the second control unit 30, the switching control unit 60, and the inverter control unit 40) may include, for example, a computer system. The computer system includes a single or a plurality of computers. The computer system provided for each of those control units may include a processor and a memory as principal hardware components thereof. The computer system serves as the agent that performs the functions of the control units according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive (magnetic disk), any of which is readable for the computer system. The processor of the computer system may be made up of a single or a plurality of electronic circuits including a semiconductor integrated circuit (IC) or a large-scale integrated circuit (LSI). Those electronic circuits may be either integrated together on a single chip or distributed on multiple chips, whichever is appropriate. Those multiple chips may be aggregated together in a single device or distributed in multiple devices without limitation.

In the power conversion system 1, at least two selected from the group consisting of the first control unit 20, the second control unit 30, the switching control unit 60, and the inverter control unit 40 may be integrated together in a single microcomputer.

An external command for each of the first control unit 20, the second control unit 30, and the inverter control unit 40 may be given by, for example, an external controller. As a communications protocol for use to communicate the external command from the controller to the first control unit 20, the second control unit 30, and the inverter control unit 40, MODBUS, controller area network (CAN), or any other serial communications protocol may be used, for example. The controller may be, for example, a controller installed in an electric vehicle. However, this is only an example and should not be construed as limiting. Alternatively, the controller may also be electric vehicle supply equipment (EVSE) or an external controller such as an energy managed unit (EMU), whichever is appropriate. Alternatively, the controller may also be another microcomputer mounted on the same board as at least one of the first control unit 20, the second control unit 30, or the inverter control unit 40.

### (3) Advantages

In a power conversion system 1 according to the first embodiment, a unidirectional AC/DC converter 2 is configured to be connected to a power grid. A bidirectional insulated DC/DC converter 3 has: a first DC input/output terminal 31 and a second DC input/output terminal 32 respectively connected to a first DC output terminal 23 and a second DC output terminal 24 of the unidirectional AC/DC converter 2; and a third DC input/output terminal 33 and a fourth DC input/output terminal 34 configured to be connected across a battery E1 of an electric vehicle. An inverter 4 has: a first DC input terminal 41 and a second DC input terminal 42 respectively connected to the first DC output terminal 23 and the second DC output terminal 24 of the unidirectional AC/DC converter 2; and a first AC output terminal 43 and a second AC output terminal 44 configured to be connected to an outlet 5. An inverter control unit 40 controls the inverter 4.

This configuration may increase the system efficiency. More specifically, while the battery E1 is not being charged, the power conversion system 1 according to the first embodiment may cause the DC/DC converter 3 convert the output voltage of the battery E1, make the inverter 4 convert the output voltage into an AC voltage, and then supply the AC voltage to the outlet 5, thus allowing the system efficiency to be increased. In short, the power conversion system 1 according to the first embodiment may supply an AC voltage of AC 100 V to the outlet 5 not via the unidirectional AC/DC converter 2, thus allowing the system efficiency to be increased.

In addition, the power conversion system 1 according to the first embodiment further includes: a first switch unit 61 connected between the first AC input terminal 21 of the unidirectional AC/DC converter 2 and the first AC output terminal 43 of the inverter 4; a second switch unit 62 connected between the second AC input terminal 22 of the unidirectional AC/DC converter 2 and the second AC output terminal 44 of the inverter 4; and a switching control unit 60 that controls the first switch unit 61 and the second switch unit 62. This allows the power conversion system 1 according to the first embodiment to supply an AC voltage from the power grid to the outlet 5 while the battery E1 is not being charged with electricity.

Furthermore, in the power conversion system 1 according to the first embodiment, while the bidirectional insulated DC/DC converter 3 is charging the battery E1 with electricity, the switching control unit 60 controls the first switch unit 61 and the second switch unit 62 to ON state. This allows the power conversion system 1 according to the first embodiment to supply an AC voltage from the power grid to the outlet 5 while the bidirectional insulated DC/DC converter 3 is charging the battery E1 with electricity.

Furthermore, in the power conversion system 1 according to the first embodiment, while the bidirectional insulated DC/DC converter 3 is not charging the battery E1 with electricity, the switching control unit 60 controls the first switch unit 61 and the second switch unit 62 to OFF state. While the bidirectional insulated DC/DC converter 3 is not charging the battery E1 with electricity, the inverter control unit 40 controls the inverter 4 to cause the bidirectional insulated DC/DC converter 3 to make voltage conversion of a first DC voltage of the battery E1 and thereby convert a second DC voltage to be output to between the first DC input/output terminal 31 and the second DC input/output terminal 32 into an AC voltage for the outlet 5. Thus, while the bidirectional insulated DC/DC converter 3 is not charging the battery E1 with electricity, the power conversion system 1 according to the first embodiment allows the bidirectional insulated DC/DC converter 3 to convert a first DC voltage of the battery E1 into a second DC voltage and allows the inverter 4 to convert the second DC voltage into an AC voltage for the outlet 5 and supply the AC voltage to the outlet 5.

Furthermore, in the power conversion system 1 according to the first embodiment, the inverter control unit 40 allows the inverter 4 to operate after a DC bus voltage between the first DC output terminal 23 and the second DC output terminal 24 has exceeded a maximum value of an AC voltage to be supplied from the power grid to the unidirectional AC/DC converter 2. This allows the power conversion system 1 according to the first embodiment to reduce the chances of a reverse current flowing from the power grid to the inverter 4.

### Second Embodiment

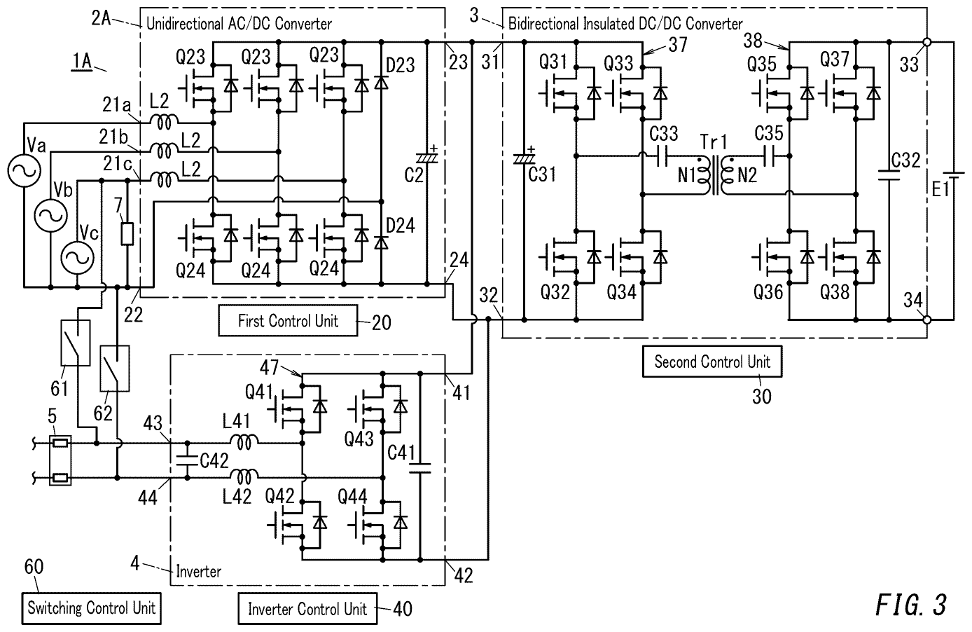

Next, a power conversion system 1A according to a second embodiment will be described with reference to FIG. 3. In the following description, any constituent element of the power conversion system 1A according to this second embodiment, having the same function as a counterpart of the power conversion system 1 (refer to FIG. 2) according to the first embodiment described above, will be designated by the same reference numeral as that counterpart's, and description thereof will be omitted herein.

### (1) Configuration

The power conversion system 1A according to the second embodiment includes a unidirectional AC/DC converter 2A instead of the unidirectional AC/DC converter 2 of the power conversion system 1 according to the first embodiment, which is a difference from the power conversion system 1 according to the first embodiment. The unidirectional AC/DC converter 2A is connected to the bidirectional insulated DC/DC converter 3.

In this power conversion system 1A, the unidirectional AC/DC converter 2A is connected, in the power grid, to a three-phase AC power supply made up of three AC power supplies Va, Vb, Vc that output AC voltages, of which the phases are different from each other by 120 degrees.

The unidirectional AC/DC converter 2A has three first AC input terminals 21a, 21b, 21c, the second AC input terminal 22, the first DC output terminal 23, and the second DC output terminal 24. In the unidirectional AC/DC converter 2A, the AC power supply Va is connected between the first AC input terminal 21a and the second AC input terminal 22. Also, in the unidirectional AC/DC converter 2A, the AC power supply Vb is connected between the first AC input terminal 21b and the second AC input terminal 22. Furthermore, in the unidirectional AC/DC converter 2A, the AC power supply Vc is connected between the first AC input terminal 21c and the second AC input terminal 22.

The unidirectional AC/DC converter 2A converts the three-phase AC voltage into a DC voltage and outputs the DC voltage to between the first DC output terminal 23 and the second DC output terminal 24.

The unidirectional AC/DC converter 2A includes three switching elements Q23 and three switching elements Q24. In this unidirectional AC/DC converter 2A, three switching circuits, in which the three switching elements Q23 are connected one to one to the three switching elements Q24, are connected to each other in parallel. In addition, the unidirectional AC/DC converter 2A further includes a series circuit of diodes D23, D24. In the unidirectional AC/DC converter 2A, the three switching elements Q23 are connected to the first DC output terminal 23 and the three switching elements Q24 are connected to the second DC output terminal 24. Besides, the unidirectional AC/DC converter 2A further includes three inductors L2. The connection node between the pair of switching elements Q23, Q24 in each of the three switching circuits is connected to a corresponding one of the three first AC input terminals 21a, 21b, 21c via a corresponding one of the inductors L2.

In the unidirectional AC/DC converter 2A, each of the three switching elements Q23 and the three switching elements Q24 may be, for example, a normally OFF n-channel MOSFET. In FIG. 3, the diodes connected in antiparallel to the three switching elements Q23 and the three switching elements Q24 are parasitic diodes for the n-channel MOSFETs serving as the three switching elements Q23 and the three switching elements Q24. However, this is only an example and should not be construed as limiting. The diodes may also be external diodes.

The three switching elements Q23 and the three switching elements Q24 are controlled by the first control unit 20. In the power conversion system 1A according to the second embodiment, the first control unit 20 generates six control signals for controlling the three switching elements Q23 and the three switching elements Q24, respectively, and outputs the six control signals.

In the power conversion system 1A, the first AC output terminal 43 of the inverter 4 is connected to the first AC input terminal 21c of the unidirectional AC/DC converter 2A via the first switch unit 61. On the other hand, the second AC output terminal 44 of the inverter 4 is connected to the second AC input terminal 22 of the unidirectional AC/DC converter 2A via the second switch unit 62.

Furthermore, in the power conversion system 1A, the voltage detector circuit 7 is connected between the first AC input terminal 21c and the second AC input terminal 22 of the unidirectional AC/DC converter 2A.

### (2) Advantages

In a power conversion system 1A according to the second embodiment, a unidirectional AC/DC converter 2A is configured to be connected to a power grid. A bidirectional insulated DC/DC converter 3 has: a first DC input/output terminal 31 and a second DC input/output terminal 32 respectively connected to a first DC output terminal 23 and a second DC output terminal 24 of the unidirectional AC/DC converter 2A; and a third DC input/output terminal 33 and a fourth DC input/output terminal 34 configured to be connected across a battery E1 of an electric vehicle. An inverter 4 has: a first DC input terminal 41 and a second DC input terminal 42 respectively connected to the first DC output terminal 23 and the second DC output terminal 24 of the unidirectional AC/DC converter 2A; and a first AC output terminal 43 and a second AC output terminal 44 configured to be connected to an outlet 5. An inverter control unit 40 controls the inverter 4.

This configuration may increase the system efficiency. More specifically, while the battery E1 is not being charged, the power conversion system 1A according to the second embodiment may cause the bidirectional insulated DC/DC converter 3 convert the output voltage of the battery E1, make the inverter 4 convert the output voltage into an AC voltage, and then supply the AC voltage to the outlet 5, thus allowing the system efficiency to be increased. In short, the power conversion system 1A according to the second embodiment may supply an AC voltage of AC 100 V to the outlet 5 not via the unidirectional AC/DC converter 2A, thus allowing the system efficiency to be increased.

### Third Embodiment

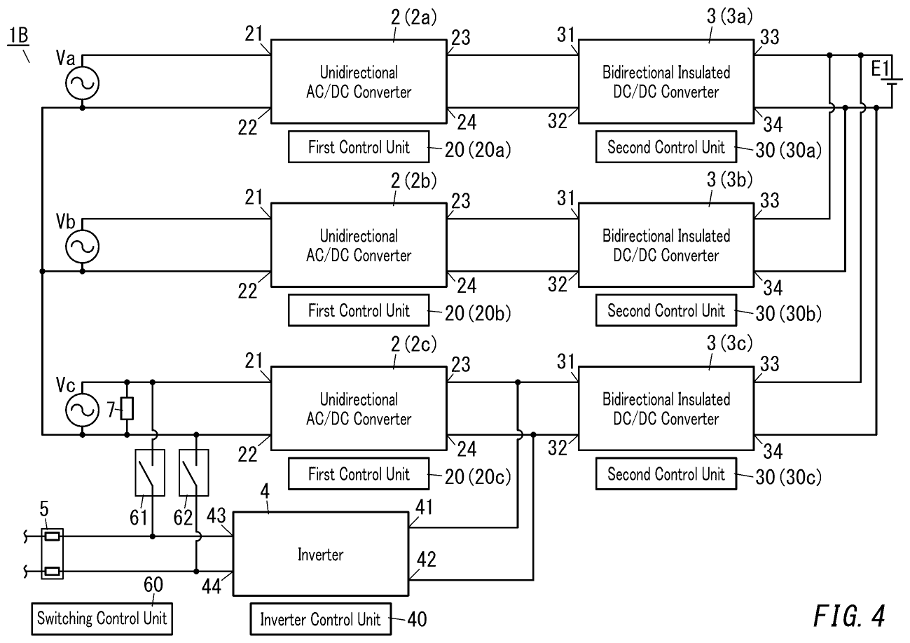

Next, a power conversion system 1B according to a third embodiment will be described with reference to FIG. 4. In the following description, any constituent element of the power conversion system 1B according to this third embodiment, having the same function as a counterpart of the power conversion system 1 (refer to FIGS. 1 and 2) according to the first embodiment described above, will be designated by the same reference numeral as that counterpart's, and description thereof will be omitted herein.

### (1) Configuration

The power conversion system 1B according to the third embodiment includes three unidirectional AC/DC converters 2, three bidirectional insulated DC/DC converters 3, three first control units 20, and three second control units 30 according to the first embodiment, which is a difference from the power conversion system 1 according to the first embodiment.

In this power conversion system 1B, the three unidirectional AC/DC converters 2 are connected, in the power grid, to a three-phase AC power supply made up of three AC power supplies Va, Vb, Vc that output AC voltages, of which the phases are different from each other by 120 degrees. In the following description, the unidirectional AC/DC converter 2 connected across the AC power supply Va will be hereinafter referred to as a “unidirectional AC/DC converter 2a,” the unidirectional AC/DC converter 2 connected across the AC power supply Vb will be hereinafter referred to as a “unidirectional AC/DC converter 2b,” and the unidirectional AC/DC converter 2 connected across the AC power supply Vc will be hereinafter referred to as a “unidirectional AC/DC converter 2c.” Also, in the following description, the bidirectional insulated DC/DC converter 3 connected to the unidirectional AC/DC converter 2a will be hereinafter referred to as a “bidirectional insulated DC/DC converter 3a,” the bidirectional insulated DC/DC converter 3 connected to the unidirectional AC/DC converter 2b will be hereinafter referred to as a “bidirectional insulated DC/DC converter 3b,” and the bidirectional insulated DC/DC converter 3 connected to the unidirectional AC/DC converter 2c will be hereinafter referred to as a “bidirectional insulated DC/DC converter 3c.” In this power conversion system 1B, the first AC output terminal 43 of the inverter 4 is connected to the first AC input terminal 21 of the unidirectional AC/DC converter 2c via the first switch unit 61. The second AC output terminal 44 of the inverter 4 is connected to the second AC input terminal 22 of the unidirectional AC/DC converter 2c via the second switch unit 62.

Also, in this power conversion system 1B, the voltage detector circuit 7 is connected between the first AC input terminal 21 and the second AC input terminal 22 of the unidirectional AC/DC converter 2c.

### (2) Advantages

In a power conversion system 1B according to the third embodiment, a unidirectional AC/DC converter 2c is configured to be connected to a power grid. A bidirectional insulated DC/DC converter 3c has: a first DC input/output terminal 31 and a second DC input/output terminal 32 respectively connected to a first DC output terminal 23 and a second DC output terminal 24 of the unidirectional AC/DC converter 2c; and a third DC input/output terminal 33 and a fourth DC input/output terminal 34 configured to be connected across a battery E1 of an electric vehicle. An inverter 4 has: a first DC input terminal 41 and a second DC input terminal 42 respectively connected to the first DC output terminal 23 and the second DC output terminal 24 of the unidirectional AC/DC converter 2c; and a first AC output terminal 43 and a second AC output terminal 44 to be connected to an outlet 5. An inverter control unit 40 controls the inverter 4.

This configuration may increase the system efficiency. More specifically, while the battery E1 is not being charged, the power conversion system 1B according to the third embodiment may cause the bidirectional insulated DC/DC converter 3c convert the output voltage of the battery E1, make the inverter 4 convert the output voltage into an AC voltage, and then supply the AC voltage to the outlet 5, thus allowing the system efficiency to be increased. In short, the power conversion system 1B according to the third embodiment may supply an AC voltage of AC 100 V to the outlet 5 not via the unidirectional AC/DC converter 2c, thus allowing the system efficiency to be increased.

In the power conversion system 1B according to the third embodiment, the first DC input terminal 41 and the second DC input terminal 42 of the inverter 4 are respectively connected to the first DC output terminal 23 and the second DC output terminal 24 of the unidirectional AC/DC converter 2c. However, this is only an example and should not be construed as limiting. Alternatively, the first DC input terminal 41 and the second DC input terminal 42 of the inverter 4 may also be respectively connected to either the first DC output terminal 23 and the second DC output terminal 24 of the unidirectional AC/DC converter 2a, instead of the unidirectional AC/DC converter 2c, or the first DC output terminal 23 and second DC output terminal 24 of the unidirectional AC/DC converter 2b, whichever is appropriate.

### Other Variations

Note that the first to third embodiments described above and their variations are only exemplary ones of various embodiments of the present disclosure and their variations and should not be construed as limiting. Rather, the first to third embodiments and their variations may be readily modified in various manners depending on a design choice or any other factor without departing from the scope of the present disclosure.

For example, each of the respective switching elements Q21, Q22, Q23, Q24, Q31-Q38, and Q41-Q44 does not have to be an n-channel MOSFET but may also be a p-channel MOSFET. Also, in the embodiments described above, each of the respective switching elements Q21, Q22, Q23, Q24, Q31-Q38, and Q41-Q44 is an Si-based MOSFET. However, this is only an example and should not be construed as limiting. Alternatively, each of those switching elements may also be an SiC-based MOSFET. Furthermore, each of the respective switching elements Q21, Q22, Q23, Q24, Q31-Q38, and Q41-Q44 does not have to be a MOSFET but may also be, for example, a bipolar transistor, an IGBT, or a GaN-based GIT.

Also, the circuit configuration of the unidirectional AC/DC converter 2 is not limited to the circuit configuration shown in FIG. 2 but may also be any other suitable circuit configuration. For example, the unidirectional AC/DC converter 2 does not have to have the circuit configuration according to the first embodiment but may also be, for example, a totem-pole PFC circuit or a semi-bridge PFC circuit as well. Likewise, the circuit configuration of the unidirectional AC/DC converter 2A is not limited to the circuit configuration shown in FIG. 3 but may also be any other suitable circuit configuration.

Furthermore, the circuit configuration of the bidirectional insulated DC/DC converter 3 does not have to be the circuit configurations shown in FIGS. 2 and 3 but may also be any other suitable circuit configuration. In the first to third embodiments described above, a CLLC circuit, which is a bidirectional version of an LLC circuit, is adopted. However, this is only an example and should not be construed as limiting. Alternatively, any other DC/DC converter may also be adopted as long as the DC/DC converter is an insulated type and may perform charging and discharging operations. The bidirectional insulated DC/DC converter 3 may be, for example, a DAB converter or an FSFB converter.

Furthermore, the battery E1 does not have to be a lithium-ion battery but may also be, for example, a solid-state battery.

Furthermore, in the embodiments described above, the power conversion system 1A, 1B includes the first switch unit 61, the second switch unit 62, and the switching control unit 60. Alternatively, the power conversion system 1A, 1B may also have a configuration without the first switch unit 61, the second switch unit 62, or the switching control unit 60.

Optionally, the power conversion system 1A, 1B may include a plurality of inverters 4. In that case, the first DC input terminal 41 and the second DC input terminal 42 of each of the plurality of inverters 4 may be respectively connected to the first DC output terminal 23 and the second DC output terminal 24 of the unidirectional AC/DC converter 2, 2A.

### Aspects

The foregoing description provides specific implementations for the following aspects of the present disclosure.

A power conversion system (1; 1A; 1B) according to a first aspect includes a unidirectional AC/DC converter (2; 2A), a bidirectional insulated DC/DC converter (3), an inverter (4), and an inverter control unit (40). The unidirectional AC/DC converter (2; 2A) has a first AC input terminal (21; 21c), a second AC input terminal (22), a first DC output terminal (23), and a second DC output terminal (24). The unidirectional AC/DC converter (2; 2A) is configured to be connected to a power grid. The bidirectional insulated DC/DC converter (3) has: a first DC input/output terminal (31) and a second DC input/output terminal (32) respectively connected to the first DC output terminal (23) and the second DC output terminal (24) of the unidirectional AC/DC converter (2; 2A); and a third DC input/output terminal (33) and a fourth DC input/output terminal (34) configured to be connected across a battery (E1) of an electric vehicle. The inverter (4) has: a first DC input terminal (41) and a second DC input terminal (42) respectively connected to the first DC output terminal (23) and the second DC output terminal (24) of the unidirectional AC/DC converter (2; 2A); and a first AC output terminal (43) and a second AC output terminal (44) configured to be connected to an outlet (5). The inverter control unit (40) controls the inverter (4).

This aspect allows for increasing the system efficiency.

A power conversion system (1; 1A; 1B) according to a second aspect, which may be implemented in conjunction with the first aspect, further includes a first switch unit (61), a second switch unit (62), and a switching control unit (60). The first switch unit (61) is connected between the first AC input terminal (21; 21c) of the unidirectional AC/DC converter (2; 2A) and the first AC output terminal (43) of the inverter (4). The second switch unit (62) is connected between the second AC input terminal (22) of the unidirectional AC/DC converter (2; 2A) and the second AC output terminal (44) of the inverter (4). The switching control unit (60) controls the first switch unit (61) and the second switch unit (62).

This aspect allows an AC voltage to be supplied from the power grid to the outlet (5) while the battery (E1) is not being charged with electricity.

In a power conversion system (1; 1A; 1B) according to a third aspect, which may be implemented in conjunction with the second aspect, while the bidirectional insulated DC/DC converter (3) is charging the battery (E1) with electricity, the switching control unit (60) controls the first switch unit (61) and the second switch unit (62) to ON state.

This aspect allows an AC voltage to be supplied from the power grid to the outlet (5) while the bidirectional insulated DC/DC converter (3) is charging the battery (E1) with electricity.

In a power conversion system (1; 1A; 1B) according to a fourth aspect, which may be implemented in conjunction with the second or third aspect, while the bidirectional insulated DC/DC converter (3) is not charging the battery (E1) with electricity, the switching control unit (60) controls the first switch unit (61) and the second switch unit (62) to OFF state. While the bidirectional insulated DC/DC converter (3) is not charging the battery (E1) with electricity, the inverter control unit (40) controls the inverter (4) to cause the bidirectional insulated DC/DC converter (3) to make voltage conversion of a first DC voltage of the battery (E1) and thereby convert a second DC voltage to be output to between the first DC input/output terminal (31) and the second DC input/output terminal (32) into an AC voltage for the outlet (5).

This aspect allows, while the bidirectional insulated DC/DC converter (3) is not charging the battery (E1) with electricity, the bidirectional insulated DC/DC converter (3) to convert a first DC voltage of the battery (E1) into a second DC voltage and allows the inverter (4) to convert the second DC voltage into an AC voltage for the outlet (5) and supply the AC voltage to the outlet (5).

In a power conversion system (1; 1A; 1B) according to a fifth aspect, which may be implemented in conjunction with any one of the first to fourth aspects, the inverter control unit (40) allows the inverter (4) to operate after a DC bus voltage between the first DC output terminal (23) and the second DC output terminal (24) has exceeded a maximum value of an AC voltage to be supplied from the power grid to the unidirectional AC/DC converter (2; 2A).

This aspect may reduce the chances of a reverse current flowing from the power grid to the inverter (4).

### Reference Signs List

1, 1A, 1B Power Conversion System
2, 2A Unidirectional AC/DC Converter
20 First Control Unit
21, 21a, 21b, 21c First AC Input Terminal
22 Second AC Input Terminal
23 First DC Output Terminal
24 Second DC Output Terminal
3 Bidirectional Insulated DC/DC Converter
30 Second Control Unit
31 First DC Input/Output Terminal
32 Second DC Input/Output Terminal
33 Third DC Input/Output Terminal
34 Fourth DC Input/Output Terminal
4 Inverter
40 Inverter Control Unit
41 First DC Input Terminal
42 Second DC Input Terminal
43 First AC Output Terminal
44 Second AC Output Terminal
5 Outlet
60 Switching Control Unit
61 First Switch Unit
62 Second Switch Unit
7 Voltage Detector Circuit
E1 Battery
Vs AC Power Supply
Va, Vb, Vc AC Power Supply

1. A power conversion system comprising:
a unidirectional AC/DC converter having a first AC input terminal, a second AC input terminal, a first DC output terminal, and a second DC output terminal and configured to be connected to a power grid;
a bidirectional insulated DC/DC converter having: a first DC input/output terminal and a second DC input/output terminal respectively connected to the first DC output terminal and the second DC output terminal of the unidirectional AC/DC converter; and a third DC input/output terminal and a fourth DC input/output terminal configured to be connected across a battery of an electric vehicle;
an inverter having: a first DC input terminal and a second DC input terminal respectively connected to the first DC output terminal and the second DC output terminal of the unidirectional AC/DC converter; and a first AC output terminal and a second AC output terminal configured to be connected to an outlet; and
an inverter control unit configured to control the inverter.

2. The power conversion system of claim 1, further comprising:
a first switch unit connected between the first AC input terminal of the unidirectional AC/DC converter and the first AC output terminal of the inverter;
a second switch unit connected between the second AC input terminal of the unidirectional AC/DC converter and the second AC output terminal of the inverter; and
a switching control unit configured to control the first switch unit and the second switch unit.

3. The power conversion system of claim 2, wherein
the switching control unit is configured to, while the bidirectional insulated DC/DC converter is charging the battery with electricity, control the first switch unit and the second switch unit to ON state.

4. The power conversion system of claim 2, wherein
the switching control unit is configured to, while the bidirectional insulated DC/DC converter is not charging the battery with electricity, control the first switch unit and the second switch unit to OFF state, and
the inverter control unit is configured to, while the bidirectional insulated DC/DC converter is not charging the battery with electricity, control the inverter to cause the bidirectional insulated DC/DC converter to make voltage conversion of a first DC voltage of the battery and thereby convert a second DC voltage to be output to between the first DC input/output terminal and the second DC input/output terminal into an AC voltage for the outlet.

5. The power conversion system of claim 1, wherein
the inverter control unit is configured to allow the inverter to operate after a DC bus voltage between the first DC output terminal and the second DC output terminal has exceeded a maximum value of an AC voltage to be supplied from the power grid to the unidirectional AC/DC converter.

6. The power conversion system of claim 3, wherein
the switching control unit is configured to, while the bidirectional insulated DC/DC converter is not charging the battery with electricity, control the first switch unit and the second switch unit to OFF state, and
the inverter control unit is configured to, while the bidirectional insulated DC/DC converter is not charging the battery with electricity, control the inverter to cause the bidirectional insulated DC/DC converter to make voltage conversion of a first DC voltage of the battery and thereby convert a second DC voltage to be output to between the first DC input/output terminal and the second DC input/output terminal into an AC voltage for the outlet.

7. The power conversion system of claim 2, wherein
the inverter control unit is configured to allow the inverter to operate after a DC bus voltage between the first DC output terminal and the second DC output terminal has exceeded a maximum value of an AC voltage to be supplied from the power grid to the unidirectional AC/DC converter.

8. The power conversion system of claim 3, wherein
the inverter control unit is configured to allow the inverter to operate after a DC bus voltage between the first DC output terminal and the second DC output terminal has exceeded a maximum value of an AC voltage to be supplied from the power grid to the unidirectional AC/DC converter.

9. The power conversion system of claim 4, wherein
the inverter control unit is configured to allow the inverter to operate after a DC bus voltage between the first DC output terminal and the second DC output terminal has exceeded a maximum value of an AC voltage to be supplied from the power grid to the unidirectional AC/DC converter.

10. The power conversion system of claim 6, wherein
the inverter control unit is configured to allow the inverter to operate after a DC bus voltage between the first DC output terminal and the second DC output terminal has exceeded a maximum value of an AC voltage to be supplied from the power grid to the unidirectional AC/DC converter.
